(19) United States
(12) Patent Application Publication
(10) Pub. No.: US 2015/0347388 A1
(43) Pub. Date: Dec. 3, 2015

(54) Digital Content Genre Representation

(71) Applicant: Google Inc., Mountain View, CA (US)

(72) Inventor: Yang Lu, San Jose, CA (US)

(73) Assignee: Google Inc., Mountain View, CA (US)

(21) Appl. No.: 14/294,320

(22) Filed: Jun. 3, 2014

(51) Int. Cl. G06F 17/27; G06F 17/28

(52) U.S. Cl. CPC G06F 17/2735; G06F 17/28

(57) ABSTRACT

A digital media store may receive content from a content creator and/or distributor thereof. The distributor may provide the content with a label genre. A first mapping rule may be applied to the label genre to convert it to a canonical genre and the canonical genre may be converted to a regional genre based on the application of a second mapping rule. The regional genre may be presented to a consumer's electronic device along with a translation, if necessary.

### BACKGROUND

A digital media store may collect and/or provide content (e.g., a song, an album, a playlist, a video, an electronic book, an electronic magazine, an application, etc.) to consumers' electronic devices that are capable of interfacing with the media store. A substantial volume of digital content is accessible in such digital media stores. Often, a consumer may elect to browse the content by applying a filter (e.g., by rating, genre, creator, date, popularity, etc.) to the content to facilitate the consumer's discovery of new content. Digital content, for example, may be described by a variety of different genres and each of the genres may differ depending on the distributor of the content and the region in which the content is provided. A genre may refer to a category that is defined based on a collection of stylistic criteria. For example, classical music may be defined as music belonging to a specified period of time and containing violins and a piano. The stylistic criteria that define a genre may change. Thus a genre's definition may be dynamic.

### BRIEF SUMMARY

According to an implementation, a digital media store may receive a song from a music label for which the music label has assigned a label genre. A first mapping rule may be applied to convert the label genre to a first canonical genre. Every music genre submitted to the digital media store may map to a canonical genre. A second mapping rule may be applied to convert the first canonical genre to at least one regional genre. Each regional genre may correspond to a subset of the canonical genres available in a first region. A translation may be generated for the regional genre for display by the media store. An electronic device of a consumer browsing the media store may be provided with a regional genre and translation.

In an implementation, a system is provided that includes a database and a processor connected thereto. The database may store at least one of a label genre, a canonical genre, and/or a regional genre. The processor may be configured to receive, by a digital media store, a song from a music label for which the music label has assigned a label genre. The processor may apply a first mapping rule to convert the label genre to a first canonical genre. Every music genre submitted to the digital media store may map to exactly one canonical genre. A second mapping rule may be applied to convert the first canonical genre to at least one regional genre. Each of the at least one regional genre may correspond to a subset of the canonical genres available in a first region. The processor may be configured to generate a translation of the at least one regional genre for display by the media store. The processor may provide a first of the at least one regional genre and the translation to an electronic device of a consumer browsing the media store.

In an implementation, a system according to the presently disclosed subject matter includes a means for receiving, by a digital media store, a song from a music label for which the music label has assigned a label genre. The system may include a means for applying a first mapping rule to convert the label genre to a first canonical genre. Every music genre submitted to the digital media store may map to a canonical genre. The system may include a means for applying a second mapping rule to convert the first canonical genre to at least one regional genre. Each regional genre may correspond to a subset of the canonical genres available in a first region. The system may include a means for generating a translation for the regional genre for display by the media store. The system may include a means for providing an electronic device of a consumer browsing the media store with a regional genre and translation.

Additional features, advantages, and implementations of the disclosed subject matter may be set forth or apparent from consideration of the following detailed description, drawings, and claims. Moreover, it is to be understood that both the foregoing summary and the following detailed description provide examples of implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a computer according to an implementation of the disclosed subject matter.

FIG. 2 shows a network configuration according to an implementation of the disclosed subject matter.

FIG. 3 is an example of a process to display a regional genre on an electronic device of a consumer as disclosed herein.

FIG. 4 is an example system for providing a regional genre to an electronic device of a consumer according to an implementation disclosed herein.

### DETAILED DESCRIPTION

As disclosed herein, a genre management scheme is provided that permits a reconciliation of a genre that is provided by a content distributor or the like. For example, a record label may be a content distributor; it may coordinate the production, marketing, distribution, etc. of a music artist's content. Other forms of digital content (e.g., movies, books, applications, etc.) may contain a content distributor with a function similar to that of a record label and/or distributor. Although the examples and implementations below are presented in the context of music and music genres, other forms of digital content that may be classified according to a particular genre may utilized with any of the implementations disclosed herein.

A music store provider may receive content from a content distributor. During intake of digital content, the content distributor (e.g., a label such as a record label) may submit a genre with each of the submitted pieces of digital content. A genre submitted by the label or other similar source may be referred to herein as a label genre. Each label may have its own scheme for assigning a genre to a particular piece of digital content. Thus, multiple labels may each have their own classification scheme for their respective digital content.

The label genre may be converted to a canonical genre. The canonical genre may be a unified genre definition that is not dependent on a particular region or label. A canonical genre's definition may be updated and/or segmented as needed. In some instances, a canonical genre may be defined by professional music experts. A canonical genre may be defined based on a digital analysis of the content. For example, an audio track may be analyzed for one or more features. The features may be utilized to classify the audio track using a machine learning technique. The machine learning technique may be a computer program that has been trained on a test set of data that includes music, for example, that has a generally agreed upon musical genre (e.g., rock, rhythm and blues, country, electronic, etc.). The machine learning technique may extract features of the audio tracks in the test audio track group to learn what features can successfully classify it in the appropriate musical genre. It may be based on combination of information about the musical artists, a professional music expert's opinion, and a digital analysis of the content. The canonical genre may be converted into a regional genre. The regional genre may refer to a subset of canonical genres. The regional genre may be displayed to a user of a media store in a translated form that corresponds to an appropriate language translation of each genre contained in the regional genre.

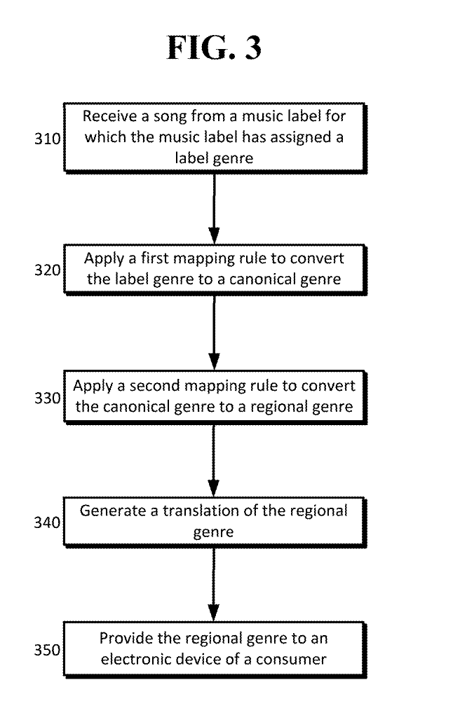

An example of an implementation for a process to display a regional genre on an electronic device of a consumer is shown in FIG. 3. A digital media store or service may receive digital content, such as a song, from a music label (e.g., a record label, distributor, or the like) at 310. The music label may have assigned a label genre to the digital content. The label genre may be based on criteria specific to the label. The content provided to consumers' electronic devices via the media store may be stored on a database that is separate from the media store. Worldwide, music labels may have different criteria which form the basis for their individual assignment of a label genre to the content they deposit in the media store. For example, a music label may assign a label of “pop” to a Chinese music group. However, such content is unlikely to be viewed by consumers in Russia as “pop” music. Russian users of the media store or the media store provider may, nonetheless, wish to have the Chinese “pop” music included in the media store or otherwise available to users of the media store. In some instances, a label may operate across more than one country. In such instances, the label may associate a country identifier with the data provided to the media store, including the digital content itself, to indicate how the content was classified. For example, a music label may receive content from Russia and China. It may label a subset of the music content it provides to the music store as “pop,” but it may include a country identifier to distinguish “pop” music originating from Russia from that originating from China. In some configurations, a mapping rule (e.g., the first mapping rule and/or second mapping rule) may be based, at least in part, upon the country identifier.

The media store may have predetermined canonical genres. A first mapping rule may be applied to the received one or more label genres to convert each label genre to a canonical genre at 320. Each label genre may be converted to one canonical genre. The first mapping rule may refer to a classification scheme for assigning a genre to digital content. The canonical genres, regional genres, and/or label genres, may each be determined by criteria that may or may not overlap. For example, professional music experts may manually classify content for a label. A digital analysis, such as a machine learning technique, of the content may be utilized to classify the content. For example, an audio track may be analyzed for features such as its tempo, bass, vocal component, instrumentation, duration, etc. to determine which genre it should be classified as. Thus, a mapping rule may refer to a classification scheme for a genre. If a machine learning technique reveals features A, B, and C as being represented at a first set of values for pop music and a second set of values for rock music, then a rule may specify that music containing A, B, and C at the specified values may be classified as pop or rock, respectively. Notably, the features may be present in some genres but not others and the value for a specific feature may be shared among more than one genre. For example, pop music may have a value of 10 for feature A, 15 for feature B, and 0 for feature C, indicating the absence of feature C. Classical music may have 10 for feature A, 0 for feature B, and 135 for feature C. A mapping rule, thus, may indicate that digital content with feature values for A, B, and C of 10, 15, and 0, respectively, is classified as pop music while digital content with values of 10, 0, and 135 may be classified as classical music.

At 330, a second mapping rule may be applied to convert the canonical genres to one or more regional genres. Each of the regional genres may correspond to a subset of the canonical genres available in a particular region. Examples of label genres and canonical genres for the media store may be represented as shown in Tables 1-3 below.

TABLE 1
examples of canonical genres and their
corresponding representations

| Representation | Genre |
|---|---|
| 1 | ALTERNATIVE_INDIE |
| 2 | ALTERNATIVE_10S |
| 3 | ALTERNATIVE_00S |
| 4 | BRIT_POP_BRI_ROCK |
| 5 | ALTERNATIVE_INDIE_AUS_DEUTSCHLAND |

TABLE 2
examples of label genres received from Label A

| | First mapping rule applied, |
|---|---|
| Label A Genres | Representation |
| “Alternative” | 1 |
| “British Trad. Rock” | 4 |
| “00s Alternative” | 3 |
| “10s Alternative” | 2 |

TABLE 3
examples of label genres received from Label B

| | First mapping rule applied, |
|---|---|
| Label B Genres | Representation |
| “Alternative/Indie” | 1 |
| “Britpop” | 4 |
| “Alternative 2000” | 3 |
| “Alternative/Indie Aus. Deutschland” | 5 |

Thus, the label genres received from Labels A and B, as shown in Tables 2 and 3 may be mapped to canonical genre shown in Table 1 by applying a first mapping rule. For example, Label A's “Alternative” genre and Label B's “Alternative/Indie” genre may be mapped to the canonical genre of “ALTERNATIVE_INDIE” as shown by Tables 1-3. A second mapping rule may be applied to the canonical genres to generate regional genres, each of which may be available in or otherwise suited to a particular locale. A genre hierarchy may be defined for each regional genre that includes a subset of the regional genres. For example, a regional genre for Region A may include “ALTERNATIVE_INDIE” as a top level genre and “ALTERNATIVE_{—}00S,” “ALTERNATIVE_{—}10S,” “BRIT_POP_BRI_ROCK,” as sub-genres of the top level genre. Similarly, a regional genre for Region B may also include “ALTERNATIVE_INDIE” as a top level genre and “ALTERNATIVE_{—}00S,” “ALTERNATIVE_{—}10S,” “ALTERNATIVE_INDIE_AUS_DEUTSCHLAND,” as sub-genres of the top level genre. A database may store a representation (e.g., a table) of the canonical genre to regional genre mappings for Region A and Region B as shown in tables 4 and 5.

TABLE 4
examples of label genres received from Label B

| Canonical Genre | Regional Genre for Region A |
|---|---|
| ALTERNATIVE_INDIE | ALTERNATIVE_INDIE |
| ALTERNATIVE_00S | ALTERNATIVE_00S |
| ALTERNATIVE_10S | ALTERNATIVE_10S |
| BRIT_POP_BRI_ROCK | BRIT_POP_BRI_ROCK |
| ALTERNATIVE_IN- | ALTERNATIVE_INDIE |
| DIE_AUS_DEUTSCHLAND | |

TABLE 5
examples of label genres received from Label B

| Canonical Genre | Regional Genre for Region B |
|---|---|
| ALTERNATIVE_INDIE | ALTERNATIVE_INDIE |
| ALTERNATIVE_00S | ALTERNATIVE_10S |
| ALTERNATIVE_10S | ALTERNATIVE_00S |
| BRIT_POP_BRI_ROCK | ALTERNATIVE_00S |
| ALTERNATIVE_IN- | ALTERNATIVE_IN- |
| DIE_AUS_DEUTSCHLAND | DIE_AUS_DEUTSCHLAND |

At 340, a translation of one or more regional genres for display by the media store may be generated. Regions A and B in the above example may correspond to countries with unique languages. A language code may be associated with each region and a language translation for each regional genre may be stored and/or provided to the consumer in the respective region. Table 6 shows an example of the language code and corresponding translation for each of the regional genres. An electronic device of a consumer may be provided with a regional genre and/or the appropriate translation at 350.

TABLE 6
examples of translations of the corresponding genres into
the corresponding language based on the language code

| | Language | |
|---|---|---|
| Genre | code | Translation |
| ALTERNATIVE_INDIE | en | Alternative/Indie |
| | ru | [symbol] |
| | | [symbol] |
| | ko | [symbol] [symbol] |
| ALTERNATIVE_10S | en | \′10s Alternative |
| | ru | [symbol] |
| | | [symbol] 2010-x |
| | ko | 2010 [symbol] [symbol] |
| ALTERNATIVE_00S | en | \′00s Alternative |
| | ru | [symbol] |
| | | [symbol] 2000-x |
| | ko | 2000 [symbol] [symbol] |
| BRIT_POP_BRI_ROCK | en | Brit Pop/Brit Rock |
| | ru | [symbol] |
| | ko | [symbol] |
| ALTERNATIVE_IN- | en | Alternative/German |
| DIE_AUS_DEUTSCHLAND | | Indie |
| | ru | [symbol] |
| | | [symbol] |
| | | [symbol] |
| | ko | [symbol] [symbol] |

In some instances, a label genre may be provided by a label and the label genre may not be defined in the media store as a canonical genre. For example, a label may provide content from an artist that represents a new genre or, over time, a new genre may be utilized to describe existing content. A song that was provided in the 1980s, for example, may have been deemed pop music shortly after its release; however, in 2014, the music may be more appropriately described as “80's music.” The media store or service handling the intake of digital content from labels, may determine that the label genre is distinct from each of the canonical genres it currently possesses. For example, a digital analysis may reveal the content represents a new style of music or the label has submitted a label genre that does not match any existing canonical genre (e.g., based on a text search of the database storing canonical music genre definitions). A new canonical genre may be generated based on the label genre that has been provided. A definition of the new canonical genre may be received may be associated with the new canonical genre. For example, features of songs associated with the new genre may be stored to a database and subsequent songs that are ingested by the system may be analyzed for those specific features.

When a consumer's electronic device accesses the media store for the first time, for example, it may communicate region information that may indicate the location of the user. A regional genre and/or translation may be automatically selected as a default region for the user based on the indicated region of the device. An indication of the region may be obtained from a variety of sources such as a GPS signal, an IP address, a device's language preference (e.g., the language selected by the user for the device), a browser language, etc. In some instances, a user may desire to select a different regional genre. For example, a French user may immigrate to the United Kingdom. The French user may be provided with a regional genre corresponding to the U.K. The user may request, for example by an option provided by the media store, to convert the media store to the French media store. The media store may, upon receipt of the request, provide the user with regional genre corresponding to the French region. Thus, the genres displayed for the music content may correspond to a regional genre that is not the default one selected for users in the U.K. region and/or the language for at least the genres as display by the media store may be French.

In some configurations, the system may automatically determine that a consumer may prefer a different regional genre than a “default” genre that may be provided based on the user's location, for example. The system may utilize one or more features about the consumer to make such a determination. For example, the consumer's electronic device may have the Russian language specified despite the consumer's default regional genre may be determined as the United States. Other features about the consumer may include, without limitation, a browsing history, a purchase history, and a language preference for one or more applications. The system may generate a recommendation for the consumer the presents the consumer with the ability to select a different regional genre than what the user would be presented based on the consumer's location. The consumer may select the different regional genre and a representation of the media store may be modified on the electronic device of the consumer to display the different regional genre. Thus, a consumer may elect to have a regional genre be presented that differs from the regional genre the consumer would be shown based on the consumer's location.

A user of the media store may have an account with the media store through which the user may consume and/or purchase digital content. The account may be associated with a user preference for digital content and/or a user's preference for the configuration of the media store (e.g., a language preference, a regional genre preference, etc.). In some instances, a user may elect to specify a genre for content the user owns. The user's specified genre may be stored to a database. In subsequent access of the song, it may be presented according to the user's preference for genre for the specific song. In some instances, the user's specification of a genre for a particular song may cause the media store, with the user's permission, to classify all of the digital content from the creator of the digital content whose genre the user changed to the genre the user specified for the one song. Thus, the regional genre for a specific consumer may be modified according to the consumer's preference.

In an implementation, an independent artist may submit content to the media store. The media store may receive, for example, a song from the independent artist for which no label genre is provided. A music genre may be classified for the song based on one or more features of the song such as demographic information about the independent artist, a machine learning technique as applied to the song, a description of the song provided by the artist (or the distributor of the song), a location of the artist, etc. A recommendation for a label genre may be generated for the song. The recommendation may include one or more music genres. A selection of one of the recommended label genres may be received. For example, the independent artist (or other provider of the content) may select from among those label genres that the system has recommended. A mapping rule may be applied to convert the selected label genre to one of the canonical genres as described earlier. In some instances, the label genre may match a canonical genre and a mapping rule may not be required to convert the selected label genre. The system may, however, make a label recommendation based on how other labels have classified their content. For example, the recommended label genre for the independent artist may match that of another label that provides content from a location that is similar to the independent artist's location. Other songs submitted by the independent artist may subsequently be associated with the selected label genre. In some instances, a consumer-identified genre for a song and/or music artist (or similar digital content creator such as an author) may be received by the media store. A mapping rule may be based, at least in part, upon the consumer-identified genre for the song. For example, several consumers may indicate that the genre identified for a particular song and/or music artist is incorrect. The system may determine modify the genre provided by the regional genre and/or canonical genre based on the changes provided by the consumers.

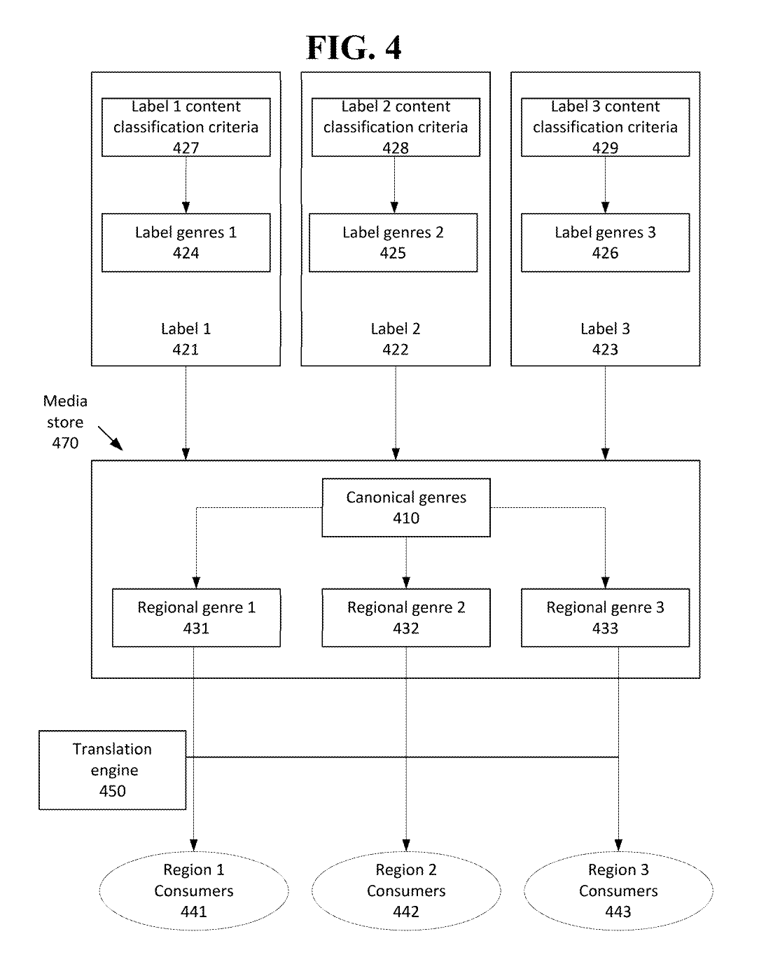

In the example system shown in FIG. 4, a database and a processor may be associated, directly or indirectly, with the media store 470. The database may store at least one label genre 421, 422, 423, one or more canonical genres 410, and at least one regional genre 441, 442, 443 as described earlier. The processor may be communicatively coupled to the database and configured to receive a song from a music label for which the music label has assigned a label genre. In FIG. 4, each of Label 1, Label 2, and Label 3 421, 422, 423 may have their own classification criteria 427, 428, 429 that they utilize to generate their respective label genres 424, 425, 426. The label genres 424, 425, 426 may be provided to the media store, or a database in configurations where the media store is merely a client-facing component. The processor may apply a first mapping rule to convert the label genre to a canonical genre. The processor may apply a second mapping rule to convert the canonical genres to at least one regional genre 431, 432, 433. Each of the regional genres 431, 432, 433 may correspond to a subset of the canonical genres available in a region. In some instances, the processor may generate a translation of the regional genre for display by the media store. In FIG. 4, the translation engine 450 is shown independent of the media store 470; however, it may be a component thereof as well as described above. The translation engine 450 may obtain language codes based on a consumer's location, for example, and the corresponding language translation for the genres included in the regional genre for the particular consumer device. In some instances, no translation may be required for a particular regional genre and the regional genre may pass directly to consumers' devices. An electronic device of a consumer browsing the media store may be provided with a regional genre and/or the translation. As shown in FIG. 3, each of the consumers for a particular region 441, 442, 443, for example as grouped by location, may receive a specific regional genre 431, 432, 433. The definition of a region may be determined by a country's boundary, a language and/or dialect, and/or other predetermined coordinates. For example, Canada may have one regional genre defined for English-speaking regions and another for French-Canadian regions.

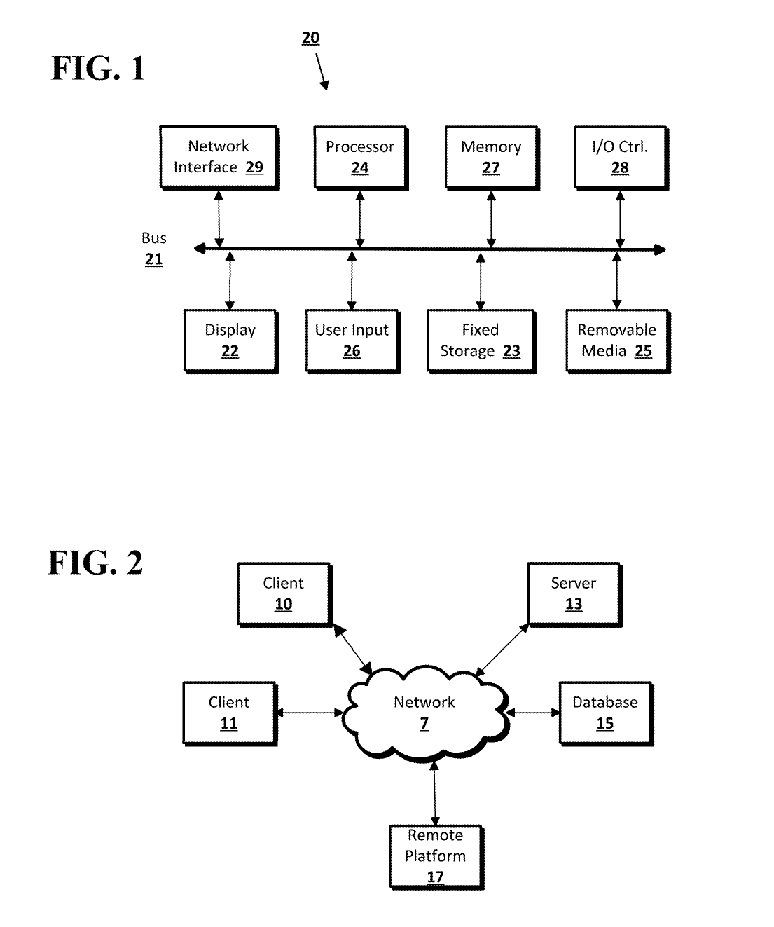

Implementations of the presently disclosed subject matter may be implemented in and used with a variety of component and network architectures. FIG. 1 is an example computer 20 suitable for implementations of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

In situations in which the implementations of the disclosed subject matter collect personal information about users, or may make use of personal information, the users may be provided with an opportunity to control whether programs or features collect user information (e.g., a user's provided input, a user's geographic location, and any other similar data associated with a user), or to control whether and/or how to receive data from a provider that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by systems disclosed herein.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method, comprising:
receiving, by a digital media store, a song from a music label for which the music label has assigned a label genre;
applying a first mapping rule to convert the label genre to a first one of a plurality of canonical genres, wherein every music genre submitted to the digital media store maps to exactly one of the plurality of canonical genres;
applying a second mapping rule to convert the first one of the plurality of canonical genres to at least one regional genre, wherein each of the at least one regional genre corresponds to a subset of the plurality of canonical genres available in a first region; and
providing, to an electronic device of a consumer browsing the media store, a first of the at least one regional genre.

2. The method of claim 1, wherein at least one of the first mapping rule and the second mapping rule is derived from a machine learning technique applied to a plurality of songs, wherein the machine learning technique comprises a digital analysis of a plurality of features of the plurality of songs.

3. The method of claim 1, further comprising:
receiving a second label genre that is undefined in the plurality of canonical genres;
determining that the second label is distinct from the each of the plurality of canonical genres; and
generating a new canonical genre based on the second label genre.

4. The method of claim 3, wherein the generating the new canonical genre comprises receiving a definition of the new canonical genre.

5. The method of claim 1, further comprising:
generating a translation of the at least one regional genre for display by the media store; and
providing, to the electronic device of the consumer browsing the media store, the translation.

6. The method of claim 5, further comprising:
obtaining an indication of the first region associated with the electronic device of the consumer, and
selecting the first of the at least one regional genre and the translation based on the indication of the first region associated with the electronic device.

7. The method of claim 6, further comprising:
receiving a request from the electronic device of the consumer to convert the media store to a second region; and
providing, to the electronic device of the consumer browsing the media store, a second of the at least one regional genre and the translation.

8. The method of claim 6, further comprising determining the first region based on at least one of a GPS signal, an IP address, a device language, and a browser language.

9. The method of claim 1, further comprising associating a country identifier with the label genre.

10. The method of claim 9, wherein the first mapping rule is based at least in part upon the country identifier.

11. The method of claim 9, wherein the second mapping rule is based at least in part upon the country identifier.

12. The method of claim 1, further comprising:
receiving a user preference for a music genre that differs from the first of the at least one regional genre;
storing an indication of the user preference; and
modifying a representation of the media store on the electronic device of the consumer based on the user preference and the first of the at least one regional genre.

13. The method of claim 1, further comprising:
determining that the consumer prefers a second of the at least one regional genre based on at least one feature associated with the consumer;
generating a recommendation for the consumer that offers the consumer the ability to select the second of the at least one regional genre despite the consumer being in the first region;
receiving a selection of the second of the at least one regional genre; and
modifying a representation of the media store on the electronic device of the consumer to show the second of the at least one regional genre.

14. The method of claim 1, further comprising:
receiving, by the digital media store, a second song from an independent artist for which no label genre is provided;
classifying a music genre for the second song based on at least one of: demographic information about the independent artist, a machine learning technique applied to the second song, a description of the second song provided by the independent artist, and a location from which the second song sent;
generating a recommendation for a second label genre for the second song;
receiving a selection of the second label genre for the second song;
applying a third mapping rule to convert the second label genre a second of the plurality of canonical genres; and
associating a third song from the independent artist for which no label genre is provided with the second label.

15. The method of claim 1, further comprising receiving an indication from the consumer of a consumer-identified genre for the song.

16. The method of claim 15, further comprising modifying the first mapping rule based upon the consumer-identified genre for the song.

17. The method of claim 15, further comprising modifying the second mapping rule based upon the consumer-identified genre for the song.

18. A system, comprising:
a database for storing at least one of a label genre, a plurality of canonical genres, and at least one regional genre;
a processor connected to the database, configured to:
receive, by a digital media store, a song from a music label for which the music label has assigned a label genre;
apply a first mapping rule to convert the label genre to a first one of the plurality of canonical genres, wherein every music genre submitted to the digital media store maps to exactly one of the plurality of canonical genres;
apply a second mapping rule to convert the first one of the plurality of canonical genres to at least one regional genre, wherein each of the at least one regional genre corresponds to a subset of the plurality of canonical genres available in a first region; and
provide, to an electronic device of a consumer browsing the media store, a first of the at least one regional genre.

19. The system of claim 18, wherein at least one of the first mapping rule and the second mapping rule is derived from a machine learning technique applied to a plurality of songs, wherein the machine learning technique comprises a digital analysis of a plurality of features of the plurality of songs.

20. The system of claim 18, the processor further configured to:
receive a second label genre that is undefined in the plurality of canonical genres;
determine that the second label is distinct from the each of the plurality of canonical genres; and
generate a new canonical genre based on the second label genre.

21. The system of claim 20, wherein the generating the new canonical genre comprises receiving a definition of the new canonical genre.

22. The system of claim 18, the processor further configured to:
generate a translation of the at least one regional genre for display by the media store; and
provide, to the electronic device of the consumer browsing the media store, the translation.

23. The system of claim 22, the processor further configured to:
obtain an indication of the first region associated with the electronic device of the consumer, and
select the first of the at least one regional genre and the translation based on the indication of the first region associated with the electronic device.

24. The system of claim 23, the processor further configured to:
receive a request from the electronic device of the consumer to convert the media store to a second region; and
provide, to the electronic device of the consumer browsing the media store, a second of the at least one regional genre and the translation.

25. The system of claim 23, the processor further configured to determine the first region based on at least one of a GPS signal, an IP address, a device language, and a browser language.

26. The system of claim 18, the processor further configured to associate a country identifier with the label genre.

27. The system of claim 26, wherein the first mapping rule is based at least in part upon the country identifier.

28. The system of claim 26, wherein the second mapping rule is based at least in part upon the country identifier.

29. The system of claim 18, the processor further configured to:
receive a user preference for a music genre that differs from the first of the at least one regional genre;
store an indication of the user preference; and
modify a representation of the media store on the electronic device of the consumer based on the user preference and the first of the at least one regional genre.

30. The system of claim 18, the processor further configured to:
determine that the consumer prefers a second of the at least one regional genre based on at least one feature associated with the consumer;
generate a recommendation for the consumer that offers the consumer the ability to select the second of the at least one regional genre despite the consumer being in the first region;
receiving a selection of the second of the at least one regional genre; and
modifying a representation of the media store on the electronic device of the consumer to show the second of the at least one regional genre.

31. The system of claim 18, the processor further configured to:
receive, by the digital media store, a second song from an independent artist for which no label genre is provided;
classify a music genre for the second song based on at least one of: demographic information about the independent artist, a machine learning technique applied to the second song, a description of the second song provided by the independent artist, and a location from which the second song sent;
generate a recommendation for a second label genre for the second song;
receive a selection of the second label genre for the second song;
apply a third mapping rule to convert the second label genre a second of the plurality of canonical genres; and
associate a third song from the independent artist for which no label genre is provided with the second label.

32. The system of claim 18, the processor further configured to receive an indication from the consumer of a consumer-identified genre for the song.

33. The system of claim 32, the processor further configured to modify the first mapping rule based upon the consumer-identified genre for the song.

34. The system of claim 32, the processor further configured to modify the second mapping rule based upon the consumer-identified genre for the song.
